(19) United States
(12) Patent Application Publication
(10) Pub. No.: US 2012/0034821 A1
(43) Pub. Date: Feb. 9, 2012

(54) AC ADAPTER

(75) Inventor: Haruo Hayakawa, Kanagawa (JP)

(73) Assignee: PANASONIC CORPORATION, Osaka (JP)

(21) Appl. No.: 13/262,847

(22) PCT Filed: Mar. 23, 2011
(86) PCT No.: PCT/JP2011/001713

§ 371 Date: Oct. 4, 2011

(30) Foreign Application Priority Data
Mar. 25, 2010 (JP) 2010-069634

(51) Int. Cl. H01R 24/28

(52) U.S. Cl. 439/660

(57) ABSTRACT

There is provided an AC adapter to which an external connection cable is detachable and which can easily preventing intrusion of foreign substances from an external connection connector while the cable is detached and the AC adapter is not in use. The AC adapter including a rotatable AC plug part and having a recess part configured to store the AC plug part while the AC adapter is not in use, and an insertion port of the external connection connector is arranged so as to oppose the recess part. Accordingly, the insertion port of the external connection connector is covered with the AC plug part. Therefore, it is possible to prevent intrusion of foreign substances into the external connection connector.

### TECHNICAL FIELD

The present invention relates to an AC adapter provided with a connector which can be connected to an exterior.

### BACKGROUND ART

It is known that a repeatedly chargeable battery is mounted on a portable terminal device such as a digital camera or a mobile phone, and power is supplied any time to the portable terminal device from the battery having been charged, thereby facilitating convenience of the users.

The battery is charged, generally, by connecting a connector for external connection provided on the portable terminal device to an outlet provided on a wall or the like, by means of a predetermined AC adapter. Specifically, a plug part at a distal end of a cable provided on the AC adapter is engaged with the outlet. Accordingly, the power required for charging the portable terminal device is supplied to the portable terminal device from a commercial power supply provided on the wall or the like.

Recently, there is proposed a technique in which a cable part in the AC adapter is made detachable, and this cable part is used for conducting transmission and reception of data to and from another device. According to the technique, in case where the cable is used in the AC adapter, it is possible to charge, and in case where the cable is connected to a personal computer or the like, it is possible to transmit and receive the data.

Moreover, portability of the AC adapter is also required for its purpose of use. As a manner of carrying the AC adapter, it is considered, for example, to put the AC adapter in a bag or the like. In this case, in case where blades of an AC plug part are kept exposed to the exterior of the AC adapter, the blades of the AC plug part may damage the device such as the mobile phone which is also contained in the bag together with the AC adapter. For this reason, the AC adapter in which the blades of the AC plug part are stored in a recess part formed in a casing of the AC adapter so that the blades do not protrude from an end surface of the casing of the AC adapter has been proposed (Patent Document 1, for example).

An example of the AC adapter which has been proposed is shown in FIG. 7. The AC adapter includes an AC plug part for obtaining a commercial power supply by connecting the AC plug part to an outlet provided on a wall or the like, a casing of the AC adapter including a base plate mounted thereon, and a cable including a connector plug connectable to a connector part.

Moreover, as shown in FIG. 8, when the AC adapter is used, it is possible to change an angle of the AC plug part according to its particular uses. As this angle, 90 degree as shown in FIG. 8(a), or 180 degree as shown in FIG. 8(b), for example, is generally adopted. As the results, the AC plug part can be easily inserted into the outlet, both in case where the outlet is positioned on a flat surface such as a desk, and in case where the outlet is positioned on a vertical surface such as a wall.

Moreover, while the AC adapter is not in use, the blades of the AC plug part are stored in a recess part provided in the casing of the AC adapter, so that the blades of the AC plug part may not protrude from an end surface of the casing (corresponding to an example where the angle is 0 degree, as shown in FIG. 8(c)). According to this structure, even in case where the AC adapter is stored in a bag or the like together with other electronic devices, on occasion of carrying the AC adapter, the other devices are unlikely to be damaged by the AC plug part.

### RELATED ART DOCUMENTS

### Patent Documents

Patent Document 1: JP-A-03-147283

### SUMMARY OF THE INVENTION

### Problem to be Solved by the Invention

However, in the related-art structure, in case where only the cable part is detached from the casing of the AC adapter while it is not in use, the connector part is exposed, and foreign substances from the exterior may easily enter in the connector part (See FIG. 9). As the results, a short circuit may occur when the cable is connected in a state where the foreign substances have entered in the connector part, and the AC adapter is inserted into the outlet.

The invention has been made in order to solve the related-art problems, and an object of the invention is to provide an AC adapter in which intrusion of foreign substances is prevented even though a cable is detached from an external connection connector while the AC adapter is not in use, and in case where the AC adapter is used, an insertion port is opened.

### Means for Solving the Problem

An AC adapter of the invention includes: an AC adapter casing provided with an insertion port of a connector into which an external connection cable is inserted; and an AC plug part which comprises plugs configured to engage an outlet and which is configured to move the plugs into a retracted state where the plugs do not protrude from the AC adapter casing, and the insertion port of the external connection connecter is arranged at a position such that the insertion port is covered with at least a part of the AC plug part when the AC plug part is in the retracted state.

### ADVANTAGES OF THE INVENTION

According to the above described structure, in the AC adapter according to the invention, the insertion port of the external connection connector is covered with at least a part of the plug part, when the plug part is in a retracted state, and hence, intrusion of foreign substances from the exterior can be easily prevented.

### BRIEF DESCRIPTION OF THE DRAWINGS

FIG. 1(a) is a perspective view of an AC adapter in Embodiment 1 of the invention in a state where an AC plug part is retracted (a state when the AC adapter is not in use), and FIG. 1(b) is a sectional view taken along a plane A-A.

FIG. 2(a) is a perspective view of the AC adapter in Embodiment 1 of the invention in a state where blades of the AC plug part are rotated by 90 degree to be erected, FIG. 2(b) is a sectional view taken along a plane B-B, FIG. 2(c) is a perspective view of the AC adapter in Embodiment 1 of the invention in a state where the blades of the AC plug part are rotated by 180 degree, and FIG. 2(d) is a sectional view taken along a plane C-C.

FIG. 3 is an exploded perspective view in case where only the AC plug part is detached from a casing of the AC adapter in Embodiment 1 of the invention.

FIG. 4 is a perspective view for explaining that intrusion of foreign substances is difficult, when the AC adapter is fitted to an outlet, in a state where and external connection plug is removed from the AC adapter in Embodiment 1 of the invention.

FIG. 5 is a perspective view of the AC adapter in Embodiment 1 of the invention in a state where a cable engaging an external connection plug is fitted to the AC adapter.

FIG. 6(a) is a perspective view of an AC adapter in Embodiment 2 of the invention in a state where an AC plug part is rotated by 90 degree, and FIG. 6(b) is a perspective view of the AC adapter in Embodiment 2 of the invention in a state where the AC plug part is retracted.

FIG. 7 is a structural view of a related-art AC adapter.

FIG. 8(a) is a perspective view showing a state where blades of an AC plug part in a casing of the related-art AC adapter is erected at 90 degree, FIG. 8(b) is a perspective view showing a state where the blades of the AC plug part in the casing of the related-art AC adapter is erected at 180 degree, and FIG. 8(c) is a perspective view showing a state where the blades of the AC plug part in the casing of the related-art AC adapter is erected at 0 degree.

FIG. 9 is a perspective view for explaining that intrusion of foreign substances is easy, in a state where an external connection cable is removed from the related-art AC adapter, when it is not in use.

FIG. 10 is a perspective view of the related-art AC adapter when an external connection plug is connected to a connector which is provided in the related-art AC adapter.

FIG. 11 is a view of the AC adapter according to a modification of the invention.

FIG. 12 is a view of the AC adapter according to a modification of the invention.

### MODE FOR CARRYING OUT THE INVENTION

An AC adapter according to a first aspect of the invention includes: an AC adapter casing provided with an insertion port of a connector into which an external connection cable is inserted; and an AC plug part which includes blades configured to engage an outlet and which is configured to move the blades into a retracted state where the blades do not protrude from the AC adapter casing, wherein the insertion port of the external connection connecter is arranged at a position such that the insertion port is covered with at least a part of the AC plug part when the AC plug part is in the retracted state.

In an AC adapter according to a second aspect of the invention, at least a part of the insertion port of the connector is covered with the blades of the AC plug part, in the retracted state.

Accordingly, it is possible to easily prevent intrusion of foreign substances from the exterior while the AC adapter is not in use.

In an AC adapter according to a third aspect of the invention, the AC adapter casing includes a recess part configured to store the blades of the AC plug part in the retracted state, and the insertion port of the connector is arranged in the recess part.

Accordingly, it is possible to reliably cover the insertion port of the connector, by storing the blades of the AC plug part.

In AC adapter according to a fourth aspect of the invention, the AC plug part and the AC adapter casing form a recess part having wall surfaces defined by the AC plug part and the casing and a surface opposing the outlet when the blades of the AC plug part protrude from the AC adapter casing and engage the outlet, and the insertion port of the connector is arranged in the recess part.

Accordingly, surroundings of the insertion port of the connector are covered when the blades of the AC adapter engage the outlet. Therefore, intrusion of foreign substances from the exterior can be prevented, even in case where the external connection cable is removed while the AC adapter is in use.

In an AC adapter according to a fifth aspect of the invention, the AC plug part and the AC adapter casing form a recess part having wall surfaces defined by the AC plug part and the casing when the blades of the AC plug part protrude the AC adapter casing, and a holding part of the external connection cable is stored in the recess part when the external connection cable is inserted into the insertion port.

Accordingly, even in case where an external force is applied to the cable, when the cable is inserted into the insertion port, a force for twisting the cable can be dispersed to the recess part, and therefore, it is possible to prevent breakdown of the cable and the insertion port.

In an AC adapter according to a sixth aspect of the invention, the recess part is shaped to engage the holding part of the external connection cable.

In this manner, a position of the cable can be restricted, in a state where the cable is inserted into the insertion port, and therefore, it is possible to prevent breakdown of the cable and the insertion port, even in case where an external force is applied to the cable.

Now, some embodiments of the above described invention will be described.

### Embodiment 1

Referring to Embodiment 1, a structure of the AC adapter in the embodiment of the invention will be described below.

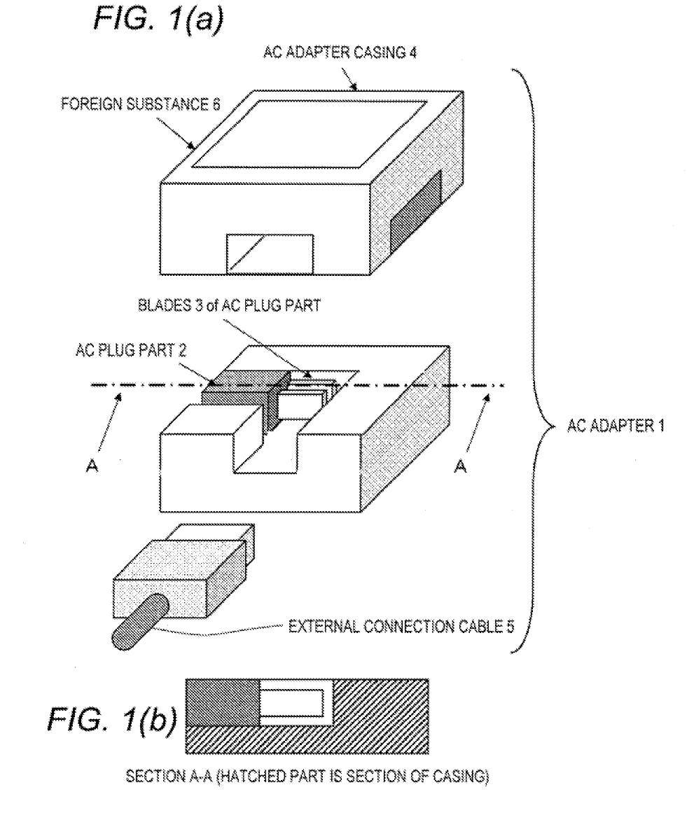

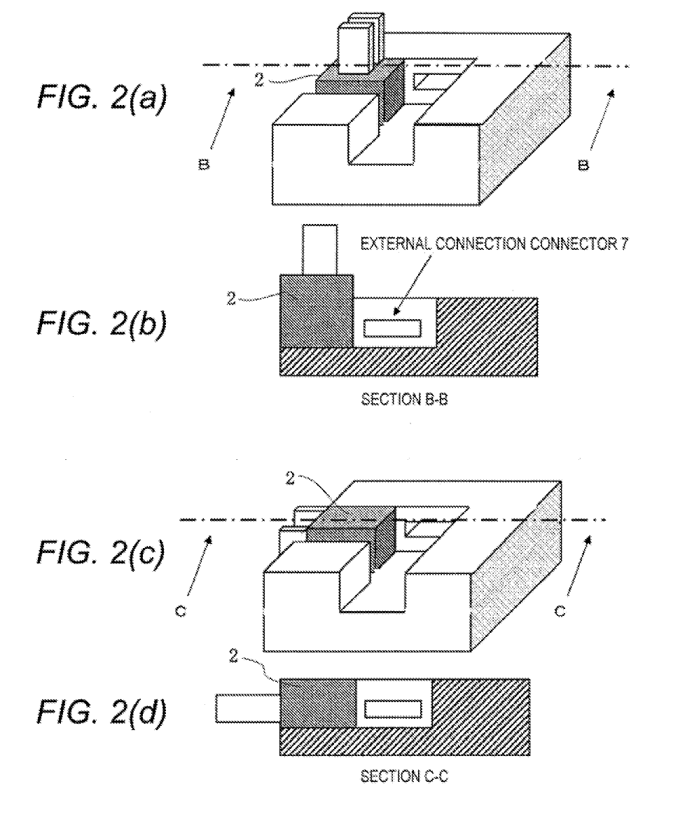

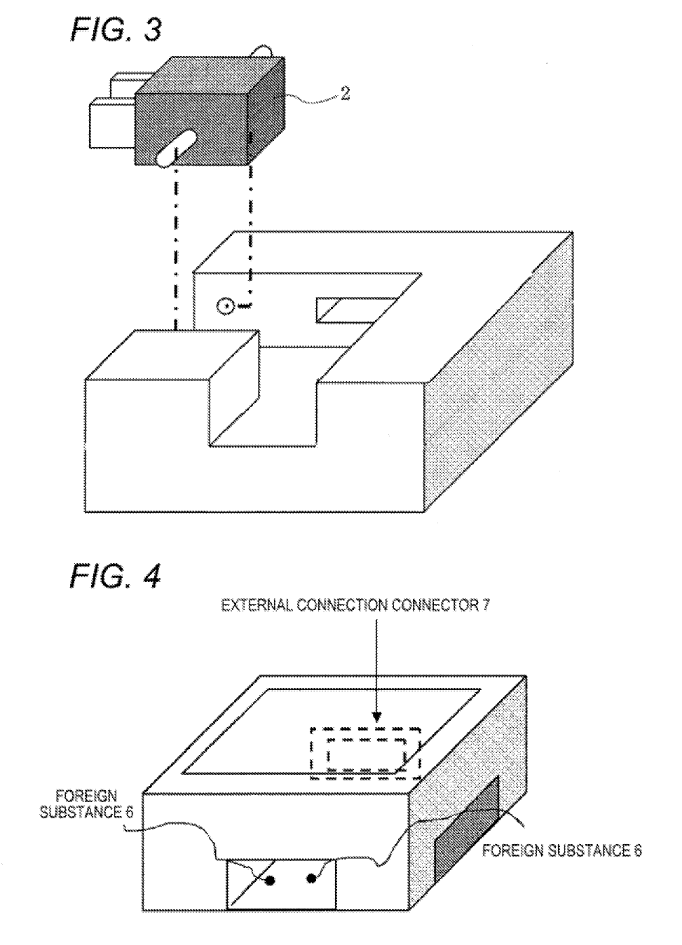

FIG. 1(a) is a perspective view of an AC adapter 1 in Embodiment 1 of the invention in a state where an AC plug part 2 is retracted (a state when the AC adapter is not in use), and FIG. 1(b) is a sectional view taken along a plane A-A in FIG. 1(a). FIG. 2(a) is a perspective view showing a state where blades 3 of an AC plug part in the AC adapter 1 is rotated by 90 degree to be erected, and FIG. 2(b) is a sectional view taken along a plane B-B in FIG. 2(a). In these drawings, a region painted in dark gray and a region including the blades 3 of the AC plug part correspond to the AC plug part 2. Moreover, FIG. 2(c) is a perspective view showing a state where the blades 3 of the AC plug part in the AC adapter 1 is rotated by 180 degree, and FIG. 2(d) is a sectional view taken along a plane C-C in FIG. 2(c). FIG. 3 is an exploded perspective view in case where only the AC plug part 2 is detached. As shown in FIG. 3, in the AC adapter 1 according to this embodiment, a rotation shaft which is provided in the AC plug part 2 is disposed so as to pass through the blades 3 of the AC plug part perpendicularly to a plane of width, and inserted into fitting holes provided in a casing 4 of the AC adapter. In this manner, the AC plug part 2 can be rotated with respect to the casing 4 of the AC adapter. It is to be noted that reference numerals of respective constituent elements of the AC adapter 1 are the same in all the drawings, unless particularly mentioned. Therefore, for enabling the drawings to be easily understood, some of the reference numerals are omitted in the drawings.

As shown in FIGS. 1 and 2, the AC adapter 1 according to this embodiment has such a structure that the blades 3 of the AC plug part are retractable in the casing 4 of the AC adapter. In the following description, a state where the blades 3 do not protrude from an end surface of the casing 4 of the AC adapter is called as a retracted state of the AC plug part. On the other hand, a state where the blades 3 protrude from the end surface of the casing 4 of the AC adapter is called as a state in use of the AC plug part.

In this embodiment, an insertion port 7a of an external connection connector 7 which is provided in the casing 4 of the AC adapter is covered with the blades 3 of the AC plug part, as shown in FIGS. 1 and 2. Specifically, in the AC adapter 1 in this embodiment, in case where the AC plug part 2 is in the retracted state, an insertion port 7a of the external connection connector is arranged at a position covered with at least a part of the Ac plug part 2 (the blades 3 of the AC plug part in FIGS. 1 and 2). In this manner, even in a state where an external connection cable 5 is detached, it is possible to prevent intrusion of foreign substances 6 from the exterior, by bringing the AC plug part 2 into the retracted state.

As the results, it is possible to prevent a phenomenon of short circuit due to connection between terminals by the foreign substances 6 which have intruded from the external connection connector 7, while the AC adapter is not in use.

Moreover, the AC adapter 1 in this embodiment is so constructed that in case where the blades 3 of the AC plug part are inserted into an outlet which is provided on a wall or the like, the external connection connector 7 is disposed in a space which is formed between the casing 4 of the AC adapter and the wall. Specifically, in the AC adapter 1 in this embodiment, the external connection connector 7 is disposed in a recess part which is enclosed between the outlet provided on the wall or the like and the casing 4 of the AC adapter. In this manner, even though the foreign substances 6 such as dust floating in the air would intrude into the external connection connector 7, an opening for intrusion of the foreign substances 6 is made narrow by an exterior of the casing 4 of the AC adapter and the outlet. Therefore, it is difficult for the foreign substances 6 or the like to intrude into the external connection connector 7, and hence, electrical malfunction due to the intrusion of the foreign substances is unlikely to occur.

Moreover, in the related-art AC adapter, the external connection connector is likely to be broken. This is because the cable part connected to the casing of the AC adapter is fixed only in a region engaging the external connection connector, while the AC adapter in a state connected to the outlet is generally in a fixed state. When an external force is applied to the cable part in this state, the force is concentrated on a plug part of the cable which engages the external connection connector (See FIG. 10). Then, a force for twisting the external connection connecter is generated, which leads to a breakdown of the AC adapter (or the plug of the cable).

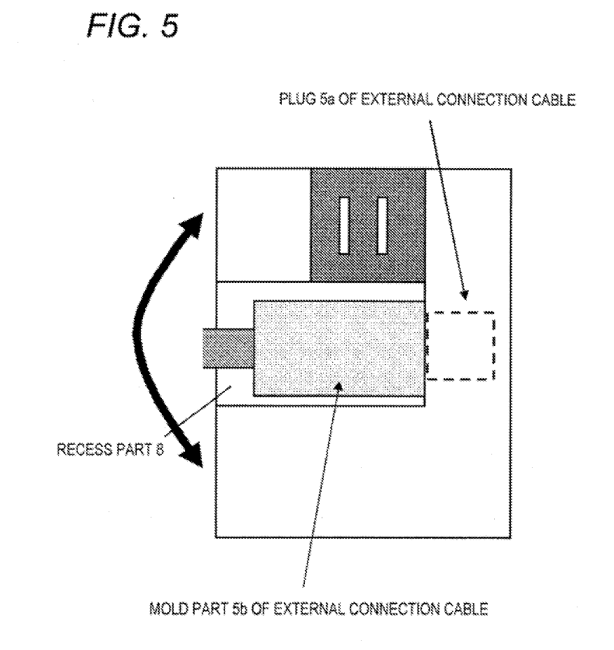

Under the circumstances, in the AC adapter in this embodiment, the external connection connector 7 is disposed together in the recess part 8 in which the blades 3 of the AC plug part are stored, and a mold part 5b (a part for holding the external connection cable) of the external connection cable 5 is also disposed in the same recess part 8, as shown in FIG. 5. In this manner, when a force is applied to the external connection cable 5, a force to be applied to the external connection connector 7 which is provided in the casing 4 of the AC adapter can be moderated. Specifically, in the AC adapter 1 in this embodiment, a position of the mold part 5b of the plug 5a provided on the external connection cable 5 is restricted by the recess part 8 in which the blades 3 of the AC plug part are stored. Specifically, in the AC adapter 1 in this embodiment, the mold part 5b of the plug 5a provided on the external connection cable 5 is shaped to engage the recess part 8 which is enclosed between the AC plug part 2 and the casing 4 of the AC adapter in the state in use, and the external connection connector 7 is provided in this recess part 8. As the results, the external force applied to the external connection cable 5 is absorbed by the mold part 5b, and the force to be applied to the external connection connector 7 is moderated. In this manner, a breakdown of the external connection connector 7 can be prevented. Moreover, it is unnecessary to make the outer shape large-sized for realizing this structure, and therefore, the breakdown of the external connection connector 7 and so on can be prevented employing an inexpensive structure.

Although in the above described embodiment, an example where the mold part 5b of the external connection cable 5 is shaped to engage the recess part 8 is shown, the invention is not limited to this. For example, even in case where only a part of the mold part 5b engages the shape of the recess part 8, or in case where the shape of the mold part 5b does not completely engage the shape of the recess part 8, because a length of the mold part 5b in a longitudinal direction is shorter than a length of the recess part 8 in the longitudinal direction, the force to be applied to the external connection connector 7 is moderated as compared with the prior art. Specifically, it is possible to employ the other structure which is different from the above described structure, provided that at least a part of the mold part 5b engages the recess part 8, in a state where the plug 5a is connected to the external connection connector 7.

Although in Embodiment 1 as described above, the intrusion of foreign substances into the external connection connector 7 provided in the AC adapter 1 is prevented by using the blades 3 of the AC plug part, the invention is not limited to this. For example, an integral component or a separate component which moves in a rotation direction of the AC plug part or in association with the blades of the AC plug part may be also used, and the invention can be realized by adding appropriate modifications and improvements.

Then, other structures of the AC adapter in which intrusion of foreign substances into the external connection connector 7 can be prevented by using the AC plug part in the retracted state or the blades of the AC plug part, which is a part of the AC plug part, will be described below.

### Embodiment 2

Then, another embodiment of the invention will be described as Embodiment 2.

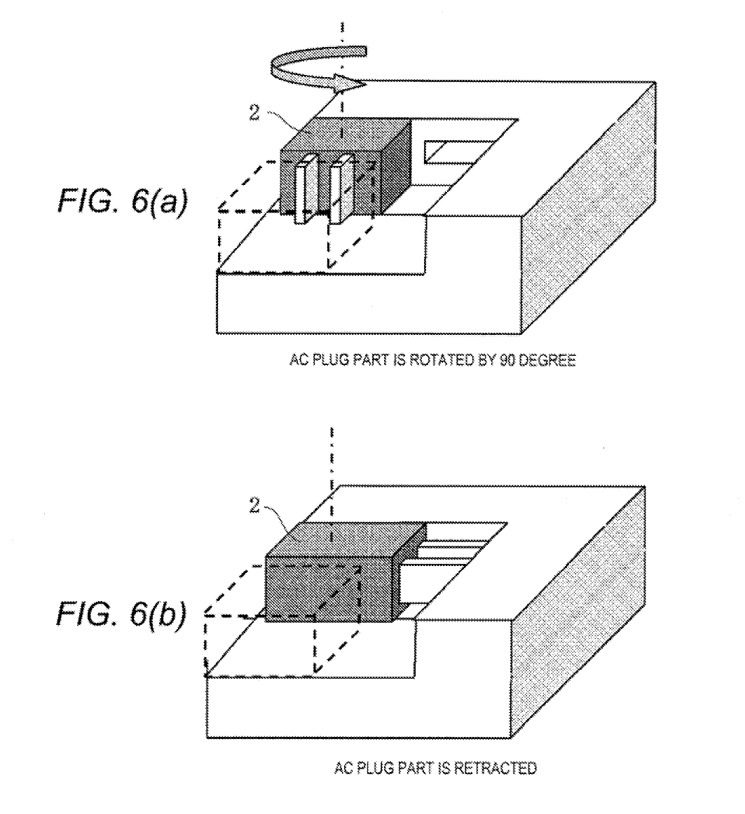

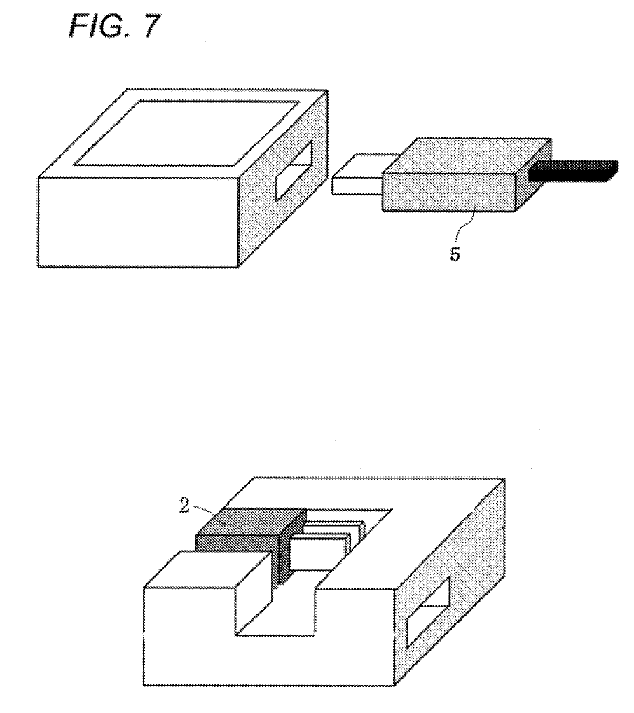

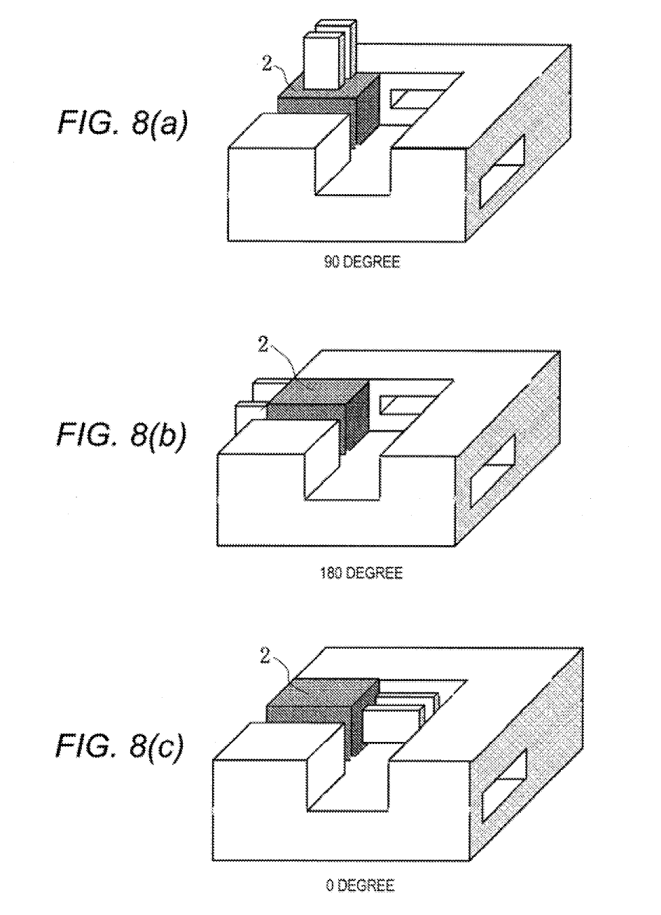

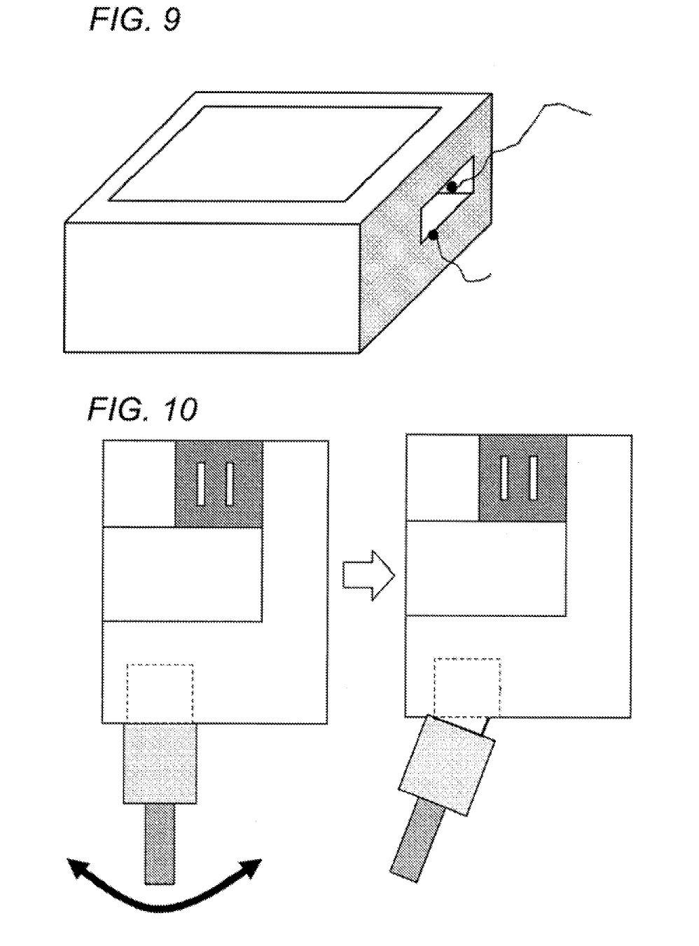

A structure of an AC adapter according to Embodiment 2 is shown in FIG. 6. FIG. 6(a) is a perspective view showing a state where an AC plug part of an AC adapter in Embodiment 2 of the invention is rotated by 90 degree, and FIG. 6(b) is a perspective view showing a state where the AC plug part of the AC adapter in Embodiment 2 of the invention is retracted. The components which are used in Embodiment 2 have the same structures as in Embodiment 1. However, Embodiment 2 is different from Embodiment 1 in a direction of rotation of the AC plug part. In the AC adapter in Embodiment 2, a rotation shaft is arranged in parallel with a plane of width of the blades of the AC plug part, as shown in FIG. 6, which is different from the structure that the AC plug part is rotated around the rotation shaft perpendicularly arranged with respect to the plane of width of the blades of the AC plug part, as shown in Embodiment 1. In this case too, it is possible to cover the insertion port of the external connection connector with the AC plug part, because the AC plug part is rotated around the rotation shaft which is arranged perpendicularly with respect to upper surfaces of the blades of the AC plug part. In this manner, substantially the same effects can be realized.

### Other Modifications

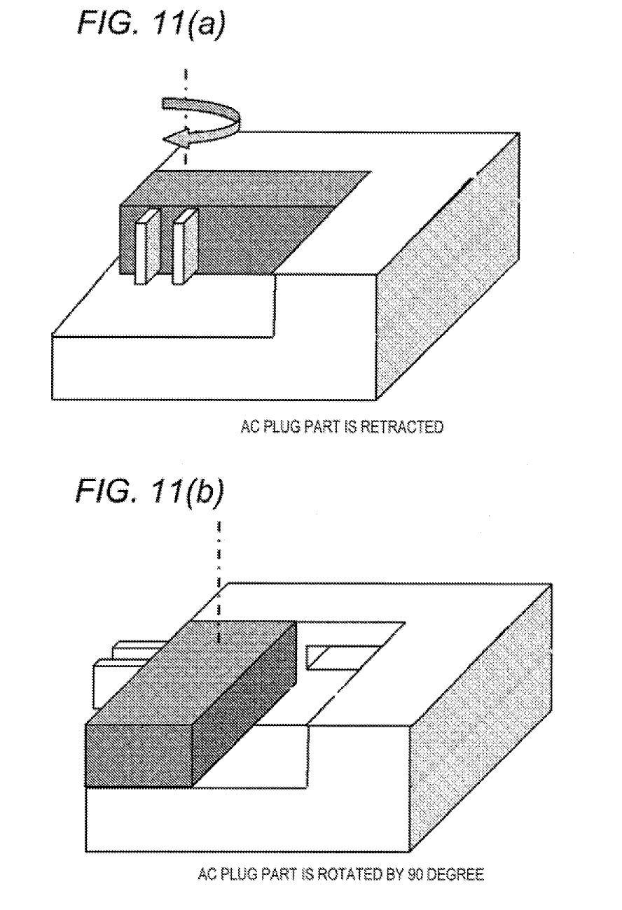

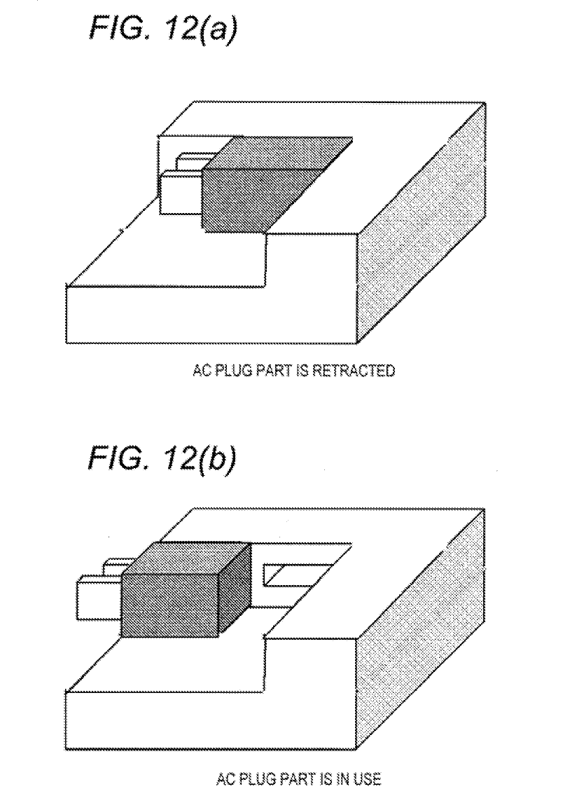

In Embodiments 1 and 2 as described above, the insertion port of the external connection connector is covered by using the blades of the AC plug part. However, the invention is not limited to this. For example, as shown in FIGS. 11 and 12, it is possible to employ such a structure that a part of the AC plug part except the blades covers the insertion port, while the AC plug part is in the retracted state. FIGS. 11 and 12 are views of the AC adapters in modifications of the invention. Specifically, it would be sufficient that the AC adapter according to the invention may have such a structure that the insertion port is covered with at least a part of the AC plug part, while the AC plug part is in the retracted state.

This application is based on Japanese Patent Application filed on Mar. 25, 2010 (Application No. 2010-069634), an entire contents of which are hereby incorporated by reference.

### INDUSTRIAL APPLICABILITY

The invention is useful in a field of the AC adapters which are used in electronic appliances.

### DESCRIPTION OF REFERENCE SIGNS

1 AC adapter
2 AC plug part
3 Blades of the AC plug part
4 Casing of the AC adapter
5 External connection cable
5a External connection plug
5b Mold part of the external connection cable
6 Foreign substances or the like
7 External connection connector

1. An AC adapter comprising:
an AC adapter casing provided with an insertion port of a connector into which an external connection cable is inserted; and
an AC plug part which comprises plugs configured to engage an outlet and which is configured to move the plugs into a retracted state where the plugs do not protrude from the AC adapter casing,
wherein the insertion port of the external connection connecter is arranged at a position such that the insertion port is covered with at least a part of the AC plug part when the AC plug part is in the retracted state.

2. The AC adapter according to claim 1,
wherein at least a part of the insertion port of the connector is covered with the plugs of the AC plug part, in the retracted state.

3. The AC adapter according to claim 1,
wherein the AC adapter casing comprises a recess part configured to store the plugs of the AC plug part in the retracted state, and
wherein the insertion port of the connector is arranged in the recess part.

4. The AC adapter according to claim 1,
wherein the AC plug part and the AC adapter casing form a recess part having wall surfaces defined by the AC plug part and the casing and a surface opposing the outlet when the blades of the AC plug part protrude from the AC adapter casing and engage the outlet, and
wherein the insertion port of the connector is arranged in the recess part.

5. The adapter according to claim 1,
wherein the AC plug part and the AC adapter casing form a recess part having wall surfaces defined by the AC plug part and the casing when the blades of the AC plug part protrude the AC adapter casing, and
wherein a holding part of the external connection cable is stored in the recess part when the external connection cable is inserted into the insertion port.

6. The AC adapter according to claim 5,
wherein the recess part is shaped to engage the holding part of the external connection cable.
